(19) United States
(12) Patent Application Publication
(10) Pub. No.: US 2024/0151403 A1
(43) Pub. Date: May 9, 2024

(54) COOKING APPLIANCE LIGHT

(71) Applicant: BJB GmbH & Co. KG, Arnsberg (DE)

(72) Inventors: Philipp Henrici, Arnsberg (DE); Olaf Baumeister, Sundern (DE); Jorg Harnischmacher, Menden (DE)

(73) Assignee: BJB GmbH & Co. KG, Arnsberg (DE)

(21) Appl. No.: 18/387,858

(22) Filed: Nov. 8, 2023

(30) Foreign Application Priority Data
Nov. 9, 2022 (DE) 202022106278.1
Mar. 31, 2023 (DE) 102023108263.9

(51) Int. Cl. F24C 15/00; F21K 9/237; F21V 3/06; F21V 29/70; F21V 33/00; F21W 131/307; F21Y 115/10

(52) U.S. Cl. CPC F24C 15/008; F21K 9/237; F21V 3/061; F21V 29/70; F21V 33/0044; F21W 2131/307; F21Y 2115/10

(57) ABSTRACT

A cooking appliance light that can be placed in a recess in the wall of a cooking appliance, in particular an oven, steam cooker, or microwave. The cooking appliance light comprises,
a sleeve, with a flange on the first end with which it can be attached to a wall in the appliance,
a central longitudinal axis, that passes through the cooking appliance light parallel to the wall of the sleeve,
securing means between the flange and the second end of the sleeve, wherein the sleeve is mounted such that the wall is between the flange and the securing means,
retaining means on the second end of the sleeve,
a light source unit, which comprises at least one LED light source on a heat sink, held by the retaining means on the second end of the sleeve,
a glass cap that covers the first end of the sleeve, wherein
the glass cap has a light entry surface facing the light source, and a light emission surface facing the interior of the cooking appliance, wherein the light entry surface of the glass cap forms a lens that acts on the light emitted from the light source toward the glass cap and passing through the glass cap in the emission direction.

The invention relates to a cooking appliance light that can be placed in a recess in the wall of a cooking appliance, in particular an oven, steam cooker, or microwave, which has,
a sleeve, with a flange on the first end with which it can be attached to a wall in the appliance,
a central longitudinal axis that passes through the cooking appliance light parallel to the wall of the sleeve,
securing means between the flange and the second end of the sleeve, wherein the sleeve is mounted such that the wall is between the flange and the securing means,
retaining means on the second end of the sleeve,
a light source unit, which comprises at least one LED light source on a heat sink, held by the retaining means on the second end of the sleeve,
a glass cap that covers the first end of the sleeve, wherein
the glass cap has a light entry surface facing the light source, and a light emission surface facing the interior of the cooking appliance.

DE 20 2019 106 170 U1, for example, discloses a cooking appliance light of this type. It is used to light the interior of such an appliance, e.g. an oven, steam cooker, or microwave. These lights must be able to withstand high temperatures. In particular in ovens, the temperatures can reach 300°. Ovens capable of pyrolysis can reach temperatures of up to 500° C.

Furthermore, fumes are generated when baking that normally contain grease and can be corrosive at high temperatures. These fumes also contain moisture, which can also be harmful. This is a major problem with steam cookers in particular, but can also be problematic with ovens and microwaves. Depending on where they are used, the lights must be able to withstand these effects, or must be sealed off effectively, particularly with steam cookers.

The use of LED light sources also requires specialized cooling. Because LED lamps are particularly sensitive to high temperatures, they must be kept as far away from the heat source as possible in the design of the cooking appliance.

Lighting the interior of the cooking appliance allows the user to observe the cooking process through the door on the appliance. This requires an effective lighting of the interior. This is particularly difficult with LED lights due to their inherent limitations. The sensitivity to high temperatures of these LED lights requires that they be kept as far away from the walls on the inside of the appliance as possible, as explained above, thus requiring that they have a comparatively long beam path. To prevent light losses between the light source and the wall of the appliance, the light emitted by the LED lights is normally conducted into the interior of the appliance using fiber optics.

The shortcoming with this technology, despite the numerous advantages, is that fiber optics are expensive. Furthermore, they must be encapsulated between the inner and outer walls of the appliance to keep them from coming in contact with the insulation therebetween. This contact would result in light losses over the length of the optical fiber.

Furthermore, the penetrations in the walls of the appliance must be tailored specifically to the use of fiber optics. This is a difficult process in the course of manufacturing the appliance, because it requires specialized tools.

The object of the invention is to therefore create a cooking appliance light that does not require fiber optics between the LED light source and the appliance walls, while still obtaining an efficient lighting of the interior of the appliance.

This problem is solved with a cooking appliance light that has the features of claim 1, in particular the characterizing features, according to which the light entry surface of the glass cap functions as a lens acting on the light coming from the light source and passing through it toward the interior of the appliance.

The cooking appliance light according to the invention takes advantage of the use of a metal sleeve, as disclosed in the prior art, which is attached to the interior wall of the appliance in a hole therein. The sleeve itself is sealed off from the appliance interior by a glass cap. This design is also used with cooking appliance lights that make use of conventional light sources, in particular incandescent lights.

The invention thus uses the sleeve as a spacer and retaining means for the LED light source. The LED light source is located at the end of the sleeve facing away from the interior wall of the appliance, and preferably secured outside of the sleeve. This allows for cooling air to flow over the LED light source, thus sufficiently cooling it.

The invention is also distinctive in that the glass cap covering the end of the sleeve is designed as a lens, in particular on its inner surface, that acts on the light exiting the glass cap, in particular diffusing it over a large surface area. This is of particular advantage if the LED light source itself has a focusing lens that focuses the light through the sleeve into the glass cap covering the end thereof. This LED lens is normally very close to the LED, i.e. directly adjacent to the LED light source.

The light entry surface on the glass cap, i.e. the optical surface thereof, is preferably concave, thus fanning out the light beams entering it.

The vertex of the concave curvature of the optical surface on the glass cap is preferably in the middle thereof, i.e. where the central longitudinal axis of the cooking appliance light passes through the glass cap.

This concave surface also extends to where the sleeve comes in contact with the glass cap. This means that the entire inner surface of the glass cap functions as a lens. It should be clear that a neck formed on the glass cap, on which a threading is formed with which it can be secured in place in the sleeve, does not form part of the lens surface.

The light emitting surface of the glass cap is preferably orthogonal to the central longitudinal axis. It can be flat or structured, in which case a structured light emitting surface can complement the function of the optically effective inner surface of the glass cap.

Further advantages of the invention are explained in the following description of exemplary embodiments of the invention.

In the drawings:

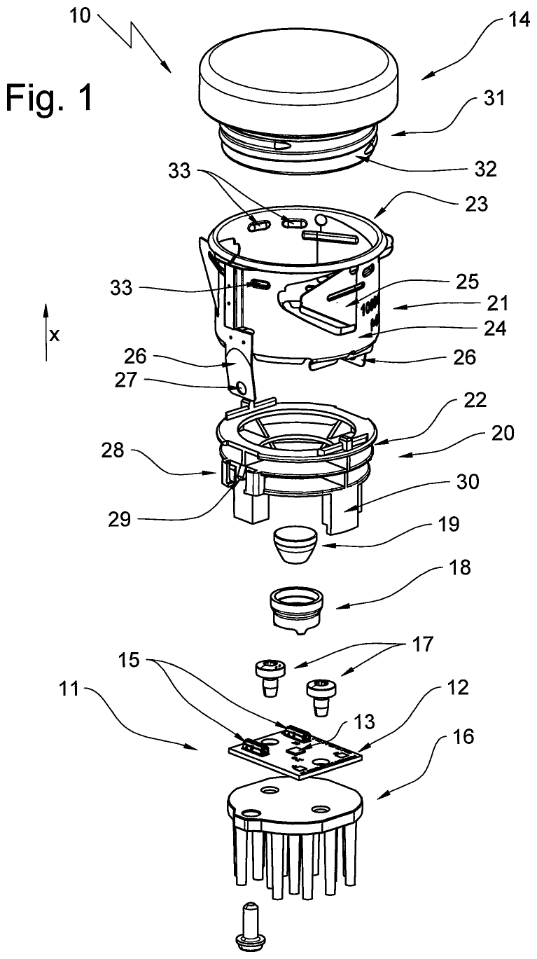

FIG. 1 shows an exploded view of a cooking appliance light according to the invention;

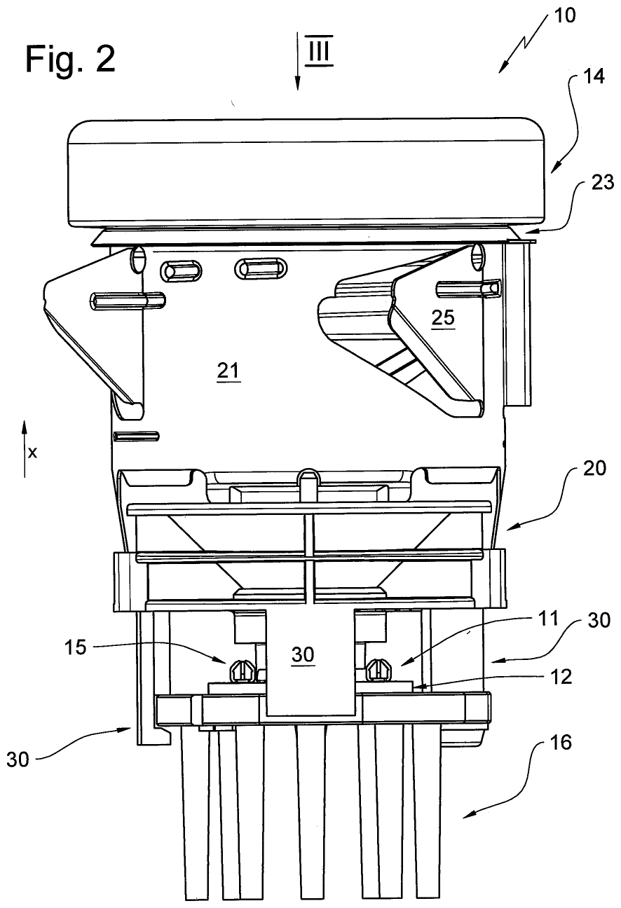

FIG. 2 shows the cooking appliance light in FIG. 1 in the assembled state;

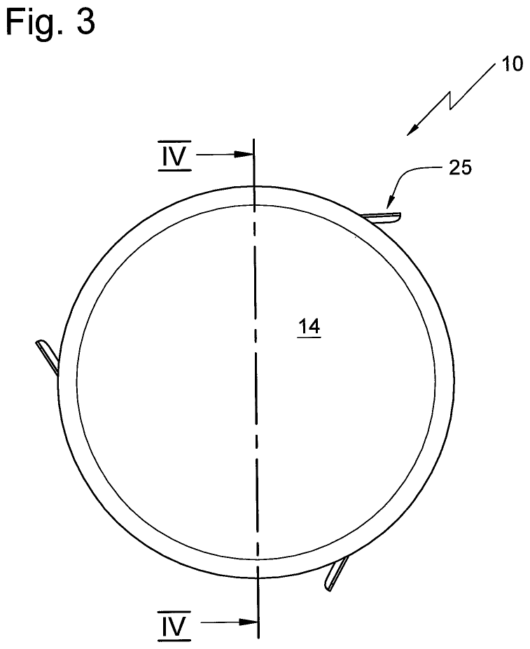

FIG. 3 shows the cooking appliance light in FIG. 1 from above;

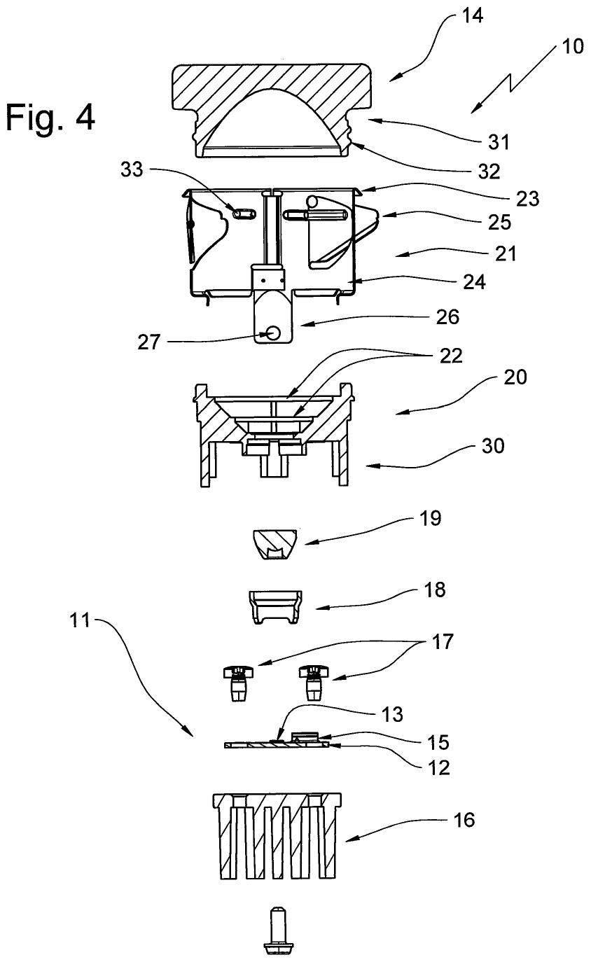

FIG. 4 shows an exploded view of the cooking appliance light, in a longitudinal cutaway view, cut along the line IV-IV indicated in FIG. 3; and

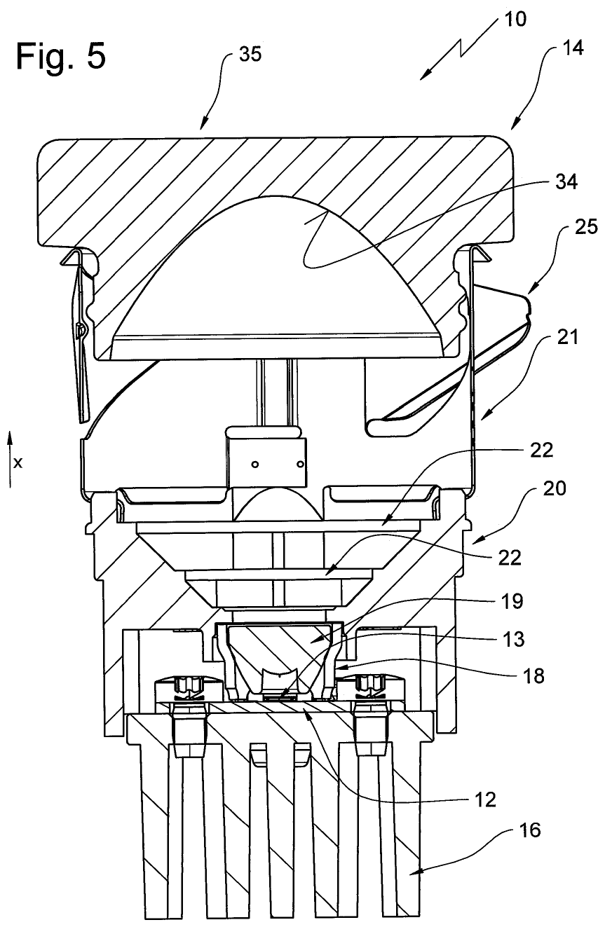

FIG. 5 shows the assembled cooking appliance light, as shown in FIG. 2, in a longitudinal cutaway view, cut along the line IV-IV indicated in FIG. 3.

The cooking appliance light as a whole is given the reference symbol 10 in the drawings.

The cooking appliance light is shown in an exploded view in FIG. 1. It comprises a light source unit 11 composed of a printed circuit board 12 with an LED light source 13 placed thereon. The light emitted from the LED light source travels along a light emission direction X toward a glass cap 14.

The printed circuit board 12 has connection terminals 15 for conductors. The printed circuit board 12 is attached to a heat sink 16 by two fasteners 17. A cup-shaped mount 18 for a lens 19 in the form of a converging lens is placed downstream of the LED light source 13 in the light emission direction X.

The printed circuit board 12, heat sink 16, and converging lens 19 are contained in a retaining means 20 and secured on a sleeve 21. The retaining means 20 has legs 30, the ends of which face away from the glass cap 14 and hold the heat sink 16 in place, to which the printed circuit board 12 with the LED light source 13 is attached. The lens mount 18 and converging lens 19 are placed in the retaining means 20. The retaining means 20 also has three washer-like disks 22 that are spaced apart along the light emission direction X, thus forming ventilation gaps between them. Each successive disk 22 in the light emission direction X is slightly larger than the preceding one.

The sleeve 21 has a first end, closer to the glass cap, which has a flange 23. The wall 24 of the sleeve has notched securing blades 25. The second end of the sleeve 21, facing away from the glass cap 14, has tabs 26 extending toward the retaining means 20, each of which has a hole 27. The tabs 26 snap in place in receivers 28 formed in the retaining means 20. Each receiver 28 has a lug 29 that engages in the hole 27 in each tab 26.

The glass cap 14 has a neck 31 facing the sleeve 21. The neck 31 has an outer threading 32. The outer threading 32 interacts with the threading 33 formed in the wall 24 of the sleeve 21. This interaction between the outer threading 32 and the inner threading 33 allows the glass cap 14 to be easily screwed into the sleeve 21.

FIG. 4 shows the assembly in FIG. 1 in a vertical cutaway view. The cutting plane follows the cutting line IV-IV shown in FIG. 3. The description of FIG. 1 also applies to FIG. 4.

FIG. 2 shows the cooking appliance light 10 in the assembled state. The glass cap 14 is screwed into the sleeve 21. The retaining means 20 is secured to the second end of the sleeve. The heat sink 16 is secured with the light source unit 11, composed primarily of the printed circuit board 12 and the LED light source 13, on the retaining means 20, and the lens mount 18 with the converging lens 19 therein is between the printed circuit board 18 and the disk 22 closest to the printed circuit board 12.

FIG. 2 shows that the cooking appliance light 10 according to the invention is a comparatively compact unit. This unit is obtained by eliminating the fiber optics between the LED light source 13 and the wall of the oven (not shown) that are used in the prior art.

The cooking appliance light 10 is placed in a hole in the wall in a cooking appliance (not shown). The sleeve 21 is largely inside the hole, such that the flange 23 bears against the inner surface of the interior wall of the cooking appliance. The securing blades 25 bear against the rear surface of the interior wall, and secure the cooking appliance light 10 in place on the interior wall of the cooking appliance.

FIG. 2 shows in particular that the light source unit 11 is clearly separated by the sleeve 21—as well as by the retaining means 20—from the glass cap 14 and therefore from the interior space of the cooking appliance (not shown). The light source unit 11, in particular the LED light source 13, is located outside the sleeve 21 and therefore outside of a heated chamber. Cooling air can flow through the numerous gaps between the second end of the sleeve 21, facing away from the glass cap 14, and the LED light source 13, which results in a sufficient cooling with regard to both the operating heat generating by the LED and the heat radiating from the interior of the cooking appliance.

FIG. 5 shows a longitudinal cut through the cooking appliance light 10, like that shown in FIG. 2. The cutting plane follows the cutting line IV-IV shown in FIG. 3. FIG. 5 shows the interior of the assembled cooking appliance light 10. The components described comprehensively in reference to FIGS. 1 and 4 are shown. In this regard, reference is made to the above descriptions of the drawings.

FIG. 5 illustrates in particular the path that the light emitted from the LED light source 13 takes. The light exits the LED light source 13 in the light emission direction X, thus toward the glass cap 14. It first strikes the lens 19 in the form of a convergent lens, which focuses the light emitted from the LED light source 13. This prevents an excessive fanning out of the light, such that the light beams are focused toward the glass cap 14. The light passes through the circular holes in the disks 22, and thus the interior of the sleeve 21.

As can be seen in the cutaway views shown in FIG. 4 and FIG. 5, the glass cap 14 has an internal light entry surface 34 facing the LED light source, which is designed as an optical surface. The light exits the glass cap 14 through the outer light emission surface 35, which faces away from the LED light source 13 and toward the interior of the cooking appliance.

The light entry surface of the glass cap 14 is concave in the light emission direction X. The vertex thereof is in the middle of the glass cap 14. This center corresponds to where a central longitudinal axis that is parallel to the wall of the sleeve, passes through the glass cap. The light entry surface 34 extends outward to where the neck 31 on the glass cap 14 bears on the sleeve 21. Aside from where the outer threading 32 is formed, the entire inner surface of the glass cap 14 forms the light entry surface 34, and therefore acts as a lens surface formed by the concave structure.

The entry surface 34 diffuses the light from the LED light source 13 focused by the converging lens 19 such that an optimal lighting of the interior of the cooking appliance is obtained. The curvature of the light entry surface 34 is adjusted to the size of the cooking appliance interior for this. Based on the position of the cooking appliance light in the interior of the cooking appliance, an appropriate curvature is selected with which the light is diffused for an optimal lighting thereof. The light entry surface 34 thus forms a lens surface.

The emission surface 35 is orthogonal to the central longitudinal axis of the sleeve 21, and can also be structured for an additional diffusion effect.

The invention shows how a compact cooking appliance light 10 can be designed without complicated fiber optics, without having to make compromises with regard to cooling the LED light source 13. What is important here is that the light source unit 11 is spaced apart from the glass cap by the sleeve 21, and located outside the sleeve 21. The glass cap 14 acting as a lens is also a substantial aspect of the invention, which diffuses the light emitted by the light source unit in order to light the interior of the cooking appliance. A substantial advantage is obtained with the converging lens downstream of the LED light source 13 in the light emission direction X. This focuses the emitted light, thus significantly minimizing light losses between the LED light source 13 and the glass cap 14.

### LIST OF REFERENCE SYMBOLS

10 cooking appliance light
11 light source unit
12 printed circuit board
13 LED light source
14 Glass cap
15 connection terminals
16 heat sink
17 fasteners
18 lens mount
19 lens/converging lens
20 retaining means
21 sleeve
22 disks
23 flange
24 sleeve wall
25 securing blades
26 tabs
27 hole
28 tab receiver
29 lug
30 legs
31 neck
32 outer threading
33 inner threading
34 light entry surface
35 light emission surface
X light emission direction

1. A cooking appliance light (10) that can be placed in a recess in the wall of a cooking appliance, in particular an oven, steam cooker, or microwave, said cooking appliance light comprising:
a sleeve (21), with a flange (23) on the first end with which it can be attached to a wall in the appliance,
a central longitudinal axis, that passes through the cooking appliance light (10) parallel to the wall of the sleeve,
securing means (25) between the flange (23) and the second end of the sleeve, wherein the sleeve is mounted such that the wall is between the flange (23) and the securing means (25),
retaining means (20) on the second end of the sleeve,
a light source unit (11), which comprises at least one LED light source (13) on a heat sink (16), held by the retaining means (20) on the second end of the sleeve,
a glass cap (14) that covers the first end of the sleeve (21), wherein:
the glass cap (14) has a light entry surface (34) facing the light source (11), and a light emission surface facing the interior of the cooking appliance, and
the light entry surface (34) of the glass cap (14) forms a lens that acts on the light emitted from the light source (11) toward the glass cap (14) and passing through the glass cap (14) in the emission direction.

2. The cooking appliance light (10) according to claim 1, wherein the lens surface diffuses light emitted from the glass cap (14).

3. The cooking appliance light (10) according to claim 1, wherein the lens surface is concave in the light emission direction (X).

4. The cooking appliance light (10) according to claim 3, wherein the vertex of the concave curvature is in the middle of the glass cap (14).

5. The cooking appliance light (10) according to claim 4, wherein the concave surface extends to where the sleeve (21) comes in contact with the glass cap (14).

6. The cooking appliance light (10) according to claim 5, wherein the light emission surface (35) is orthogonal to the central longitudinal axis.

7. The cooking appliance light (10) according to claim 6, wherein the light emission surface (35) is flat.

8. The cooking appliance light (10) according to claim 6, wherein the light emission surface (35) is structured.

9. The cooking appliance light (10) according to claim 1, wherein a converging lens (19) is placed upstream of the glass cap (14) in the light emission direction (X), which focuses the light emitted from the LED light source (13).

10. The cooking appliance light (10) according to claim 9, wherein the LED light source (13) is placed outside the sleeve (21) and in particular upstream of the sleeve (21) in the light emission direction (X).

11. The cooking appliance light (10) according to claim 2, wherein the lens surface is concave in the light emission direction (X).

12. The cooking appliance light (10) according to claim 11, wherein the vertex of the concave curvature is in the middle of the glass cap (14).

13. The cooking appliance light (10) according to claim 12, wherein the concave surface extends to where the sleeve (21) comes in contact with the glass cap (14).

14. The cooking appliance light (10) according to claim 1, wherein the light emission surface (35) is orthogonal to the central longitudinal axis.

15. The cooking appliance light (10) according to claim 2, wherein the light emission surface (35) is orthogonal to the central longitudinal axis.

16. The cooking appliance light (10) according to claim 3, wherein the light emission surface (35) is orthogonal to the central longitudinal axis.

17. The cooking appliance light (10) according to claim 4, wherein the light emission surface (35) is orthogonal to the central longitudinal axis.

18. The cooking appliance light (10) according to claim 2, wherein a converging lens (19) is placed upstream of the glass cap (14) in the light emission direction (X), which focuses the light emitted from the LED light source (13).

19. The cooking appliance light (10) according to claim 3, wherein a converging lens (19) is placed upstream of the glass cap (14) in the light emission direction (X), which focuses the light emitted from the LED light source (13).

20. The cooking appliance light (10) according to claim 4, wherein a converging lens (19) is placed upstream of the glass cap (14) in the light emission direction (X), which focuses the light emitted from the LED light source (13).
